(19) United States
(12) Patent Application Publication
(10) Pub. No.: US 2025/0306307 A1
(43) Pub. Date: Oct. 2, 2025

(54) SINTERABLE NANOPARTICLES FOR ORGANIC-FREE OPTICAL ADHESIVES

(71) Applicant: Intel Corporation, Santa Clara, CA (US)

(72) Inventors: Darren VANCE, Gilbert, AZ (US); Sufi AHMED, Chandler, AZ (US); Peter WILLIAMS, Phoenix, AZ (US); Ziyin LIN, Chandler, AZ (US); Saikumar JAYARAMAN, Chandler, AZ (US); Kumar Abhishek SINGH, Phoenix, AZ (US)

(21) Appl. No.: 18/621,543

(22) Filed: Mar. 29, 2024

(51) Int. Cl. G02B 6/42

(52) U.S. Cl. CPC G02B 6/4243; G02B 6/4239

(57) ABSTRACT

Embodiments disclosed herein include an apparatus with a first substrate, and a groove in a surface of the first substrate. In an embodiment, a fiber is in the groove, and a second substrate is over the first substrate and the fiber. In an embodiment, a porous metallic material is provided between the first substrate and the second substrate.

### GOVERNMENT LICENSE RIGHTS

This invention was made with Government support under Agreement No. N00164-19-9-0001, awarded by NSWC Crane Division. The Government has certain rights in the invention.

### BACKGROUND

Optical data links are potential candidates to address scalability challenges of electrical interconnects over long distances due to their potential for negligible frequency-dependent loss. Optical interconnects based on integrated photonics (e.g., silicon photonics) or discrete photonics (e.g., vertical cavity surface-emitting lasers (VCSELs), micro light emitting diodes (μLEDs), a photodiode (PD), etc.) are used in various applications. The optical signals from these devices are propagated along glass fibers.

Glass fibers are often set into V-grooves in a photonic integrated circuit (PIC) in order to optically couple with the photonics components of the PIC. This allows for transmission of optical signals to and/or from the PIC. In order to retain the fiber within the V-groove a lid is placed on top of the fibers. The lid is secured to the PIC by an adhesive. Often, the adhesive is an epoxy or glue. These materials are often organic in nature. In low pressure environments, such as the vacuum of space, organic adhesives are problematic. For example, outgassing in low pressure environments can lead to contamination of the optical path. This can lead to reductions in optical coupling efficiency. Additionally, extreme temperatures in harsh environments (like space) can lead to mechanical degradation by making the epoxy more brittle or by reducing the adhesive strength of the epoxy.

### BRIEF DESCRIPTION OF THE DRAWINGS

FIG. 1A is a cross-sectional illustration of a first substrate that is mechanically coupled to a second substrate by a nanoparticle paste, in accordance with an embodiment.

FIG. 1B is a cross-sectional illustration of FIG. 1A after a sintering process has caused the nanoparticles to fuse together to form a mechanical connector between the first substrate and the second substrate, in accordance with an embodiment.

FIG. 2A is a perspective view illustration of an optical system with a photonics integrated circuit (PIC) with attached fibers from a fiber array unit (FAU), in accordance with an embodiment.

FIG. 2B is a plan view illustration of a PIC with pads around V-grooves and nanoparticle paste on the pads, in accordance with an embodiment.

FIG. 2C is a plan view illustration of a lid for the PIC with pads on a surface of the lid, in accordance with an embodiment.

FIG. 2D is a plan view illustration of a PIC with a blanket pad around the V-grooves and a comb shaped area of nanoparticle paste around the V-grooves, in accordance with an embodiment.

FIG. 2E is a plan view illustration of a lid for the PIC with a blanket pad over an entire surface of the lid, in accordance with an embodiment.

FIG. 3A is a cross-sectional illustration of a PIC with a fiber from an FAU set into a V-groove of the PIC, in accordance with an embodiment.

FIG. 3B is a cross-sectional illustration of the PIC after a lid is secured to the PIC by a connector comprising a sintered nanoparticle material, in accordance with an embodiment.

FIG. 4A is a perspective view illustration of a waveguide coupler that is optically coupled to a PIC, in accordance with an embodiment.

FIG. 4B is a cross-sectional illustration of the waveguide coupler, in accordance with an embodiment.

FIG. 4C is a plan view illustration of a PIC with pads around V-grooves and nanoparticle paste on the pads, in accordance with an embodiment.

FIG. 4D is a plan view illustration of a waveguide coupler with pads on a surface of the waveguide coupler, in accordance with an embodiment.

FIG. 4E is a plan view illustration of a PIC with a blanket pad around the V-grooves and a comb shaped area of nanoparticle paste around the V-grooves, in accordance with an embodiment.

FIG. 4F is a plan view illustration of a waveguide coupler with a blanket pad over an entire surface of the waveguide coupler, in accordance with an embodiment.

FIG. 5A is a cross-sectional illustration of a PIC with a pad and a nanoparticle paste, in accordance with an embodiment.

FIG. 5B is a cross-sectional illustration of the PIC after a waveguide coupler is secured to the PIC by a connector comprising a sintered nanoparticle material, in accordance with an embodiment.

FIG. 6 is a process flow diagram of a process for coupling a fiber to a PIC with a sintered nanoparticle material, in accordance with an embodiment.

FIG. 7 is a cross-sectional illustration of an optoelectronic system that comprises a PIC mechanically coupled to a lid by a sintered nanoparticle material, in accordance with an embodiment.

FIG. 8 is a schematic of a computing device built in accordance with an embodiment.

### DETAILED DESCRIPTION

Described herein are optoelectronic systems, and more particularly, organic-free optical adhesives that comprise sintered nanoparticles, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

As noted above, organic based adhesives (e.g., epoxies, glues, etc.) are used to secure optical fibers (e.g., glass fibers) into V-grooves of a photonics integrated circuit (PIC). However, such organic based materials are not suitable for harsh environments, such as space. In space, the organic materials are prone to degassing (due to the low pressure) and mechanical degradation (due to the extreme temperatures). Degassing may result in decreases in optical transmission efficiency. Mechanical degradation can result in embrittlement, cracking, and/or loss of adhesive properties. Accordingly, existing photonics systems are not expected to have long lifespans when exposed to such environments.

Therefore, it is desirable to develop a new mechanical coupling solution that is compatible with harsh environments, such as space. As such, embodiments disclosed herein include the use of sintered nanoparticle materials in order to form connectors between substrates used in the optical coupling to a PIC or other photonics system. In the case of a fiber based system, the fibers may be aligned by a fiber array unit (FAU). The protruding fibers from the FAU are then set into V-grooves on the PIC to provide optical coupling to the PIC. A lid may be set on the fibers to keep them in the V-grooves. In an embodiment, a sintered nanoparticle connector is provided between the lid and the PIC. In the case of a waveguide coupler, the waveguide coupler comprises integrated waveguides that are set into the V-grooves of the PIC. A sintered nanoparticle connector is provided between the PIC and the waveguide coupler in order to retain the waveguides in the V-grooves.

The use of sintered nanoparticle connectors has several benefits. First, such a connector is free from organic components that easily outgas in low pressure environments. This eliminates the possibility of contamination of the optical path. Additionally, sintered nanoparticle materials are robust and compatible with extreme temperatures (i.e., both high temperatures and low temperatures). As such, there is little risk of mechanical degradation of the connector. Further, the use of a sintered nanoparticle material is an improvement over traditional solder due to the higher temperature resistance. For example, even the high temperature solders will melt at temperatures above approximately 300° C., whereas sintered nanoparticle materials have melting temperatures well above 400° C.

In embodiments disclosed herein, the sintered nanoparticle material may be formed from a nanoparticle paste. The nanoparticle paste may comprise nanoparticles of one or more different metals. In an embodiment, an average diameter of the nanoparticles in the nanoparticle paste may be up to approximately 250 nm, up to approximately 100 nm, up to approximately 50 nm, or up to approximately 25 nm. Some metals that may be suitable for use as nanoparticles may comprise one or more of copper, silver, or gold. Though, other metals may also be used in some embodiments. In an embodiment, the nanoparticle paste may comprise a flux. For example, the flux may include a water based flux, an organic flux, or the like. The flux component may be removed during the sintering process to leave behind a substantially organic-free sintered nanoparticle connector. In an embodiment, the nanoparticle paste may comprise 50% or more nanoparticle material by weight, 75% or more nanoparticle material by weight, 90% or more nanoparticle material by weight, or 95% or more nanoparticle material by weight.

In an embodiment, any suitable sintering process may be used to convert the nanoparticle paste into a sintered nanoparticle connector. For example, a heated bond head can be applied to sinter the nanoparticles, or a selective laser heating process can be used to sinter the nanoparticles. Accordingly, localized heating of the photonics structure is provided. This limits damage to other components of the photonics structure that may be sensitive to the sintering temperatures.

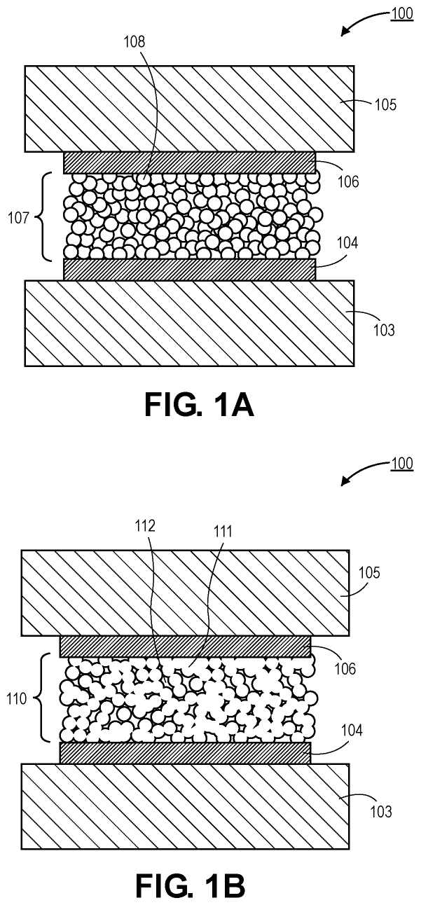

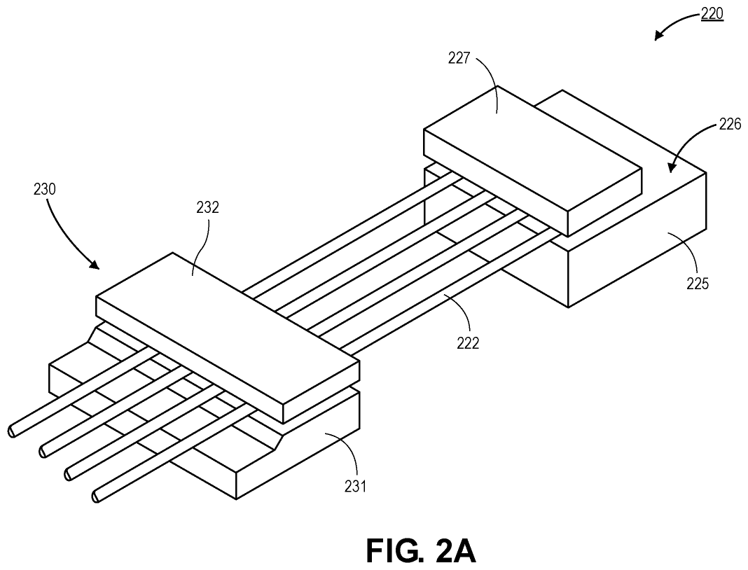

Referring now to FIGS. 1A and 1B, cross-sectional illustrations depicting a process for forming sintered nanoparticle connectors between substrates is shown, in accordance with an embodiment.

FIG. 1A is an illustration of an assembly 100 with a first substrate 103 and a second substrate 105 that is provided over the first substrate 103. In an embodiment, the first substrate 103 and the second substrate 105 may comprise any type of material or materials. In some instances, the first substrate 103 and the second substrate 105 may comprise glass materials typical of optical coupling systems. In other embodiments, at least one of the substrates 103 or 105 may comprise a semiconductor material, such as silicon or the like. Such a substrate may be part of a PIC of an optical system. Embodiments may also include materials for one or both of the first substrate 103 or the second substrate 105 that are substantially transparent to infrared (IR) radiation in order to enable some sintering operations. Suitable IR transparent substrates may include glass, fused silica, silicon, or the like.

In an embodiment, a first pad 104 may be provided on a surface of the first substrate 103, and a second pad 106 may be provided on a surface of the second substrate 105. In an embodiment, the first pad 104 and the second pad 106 may comprise metallic materials (e.g., one or more of copper, aluminum, or the like). In an embodiment the first pad 104 and the second pad 106 may have substantially the same surface area as each other. Though, in other instances, the first pad 104 may have a surface area that is different than a surface area of the second pad 106. For example, the first pad 104 may be a blanketed layer that is provided over an entire top surface of the first substrate 103, and the second pad 106 may have a smaller surface area that covers only a portion of the bottom surface of the second substrate 105.

In an embodiment, a nanoparticle paste 107 may be deposited between the first pad 104 and the second pad 106. The nanoparticle paste 107 may comprise a plurality of metallic nanoparticles 108. In an embodiment, the nanoparticle paste 107 may also comprise a flux (not shown). The nanoparticle paste 107 may be similar to the nanoparticle paste described in greater detail above. For example, the nanoparticle paste may comprise copper nanoparticles 108 with an average diameter that is up to approximately 250 nm. In the illustrated embodiment, the nanoparticles 108 are shown as being substantially circular. Though, it is to be appreciated that nanoparticles 108 may have any shaped including oblong shapes, irregular shapes, or the like. While reference is made to an “average diameter”, it is to be appreciated that the “average diameter” may also refer to an average dimension of the nanoparticles 108. For example, the dimension may include the longest straight line within the nanoparticle 108 that can be formed from a first surface of the nanoparticle 108 to a second surface of the nanoparticle 108.

Referring now to FIG. 1B, a cross-sectional illustration of the assembly 100 after a sintering process is used to form a sintered nanoparticle connector 110 is shown, in accordance with an embodiment. The sintering process may comprise a localized heating of the nanoparticle paste 107 in order to fuse the nanoparticles 108 together to form a substantially continuous structure 111 between the first pad 104 and the second pad 106. For example, the sintering process may include the application of laser energy to the nanoparticle paste 107. In other embodiments, a heated bond head can be applied over either of the substrates 103 or 105 in order to heat the nanoparticle paste 107.

The resulting sintered nanoparticle connector 110 may be described as being a porous metallic material. For example, the continuous structure 111 may comprise metallic material, with a plurality of pores 112 distributed throughout the continuous structure 111. The porosity of the sintered nanoparticle connector 110 may comprise a porosity between 0% and 75%, up to 50%, or up to 25%. As used herein, a measure of “porosity” of the sintered nanoparticle connector 110 may refer to a ratio of the area of the sintered nanoparticle connector 110 (in a cross-sectional view) that is occupied by pores 112 relative to a total area of the sintered nanoparticle connector 110 (in the cross-sectional view).

In an embodiment, the continuous structure 111 may comprise fused nanoparticles 108. For example, the surfaces of adjacent nanoparticles 108 may fuse together so that the two adjacent nanoparticles 108 form a continuous microstructure. In some embodiments, the fused nanoparticles 108 may have a seamless interface across the fused surfaces. In other embodiments, a visually detectable seam may be provided at one or more of the fused surfaces within the continuous structure.

Embodiments may also include a sintered nanoparticle connector 110 that is substantially organic-free. In cases where a flux in the nanoparticle paste 107 is present, the flux may be removed during and/or after the sintering process. Substantially organic-free may refer to a sintered nanoparticle connector 110 that has less than 10% organic material by weight, less than 5% organic material by weight, less than 1% organic material by weight, or less than 0.5% organic material by weight. In some instances, the organic-free sintered nanoparticle connector 110 may have 0% organic material by weight.

In some instances, the sintered nanoparticle connector 110 may be referred to as an organic-free adhesive material. The sintered nanoparticle connector 110 may be considered an adhesive because the continuous structure 111 may also fuse with one or both of the first pad 104 or the second pad 106. For example, one or more nanoparticles 108 may directly fuse with the first pad 104 and/or the second pad 106 during the sintering process. As such, the sintered nanoparticle connector 110 provides a mechanical bond that adheres the first substrate 103 to the second substrate 105 through the first pad 104 and the second pad 106.

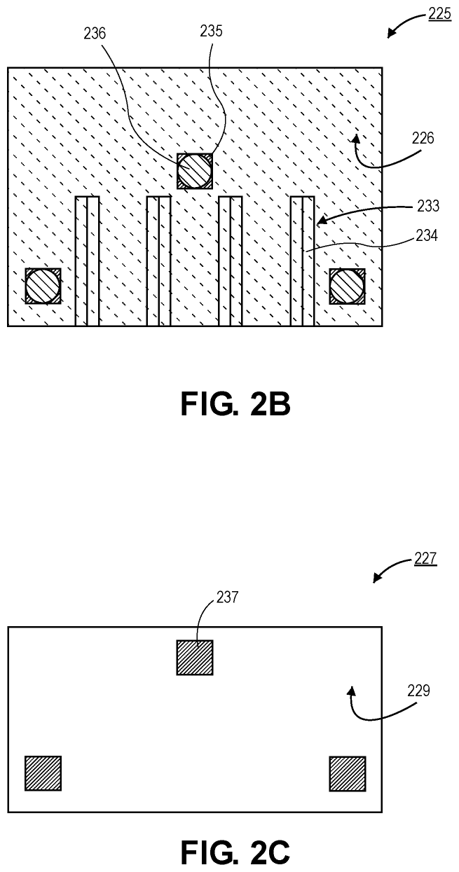

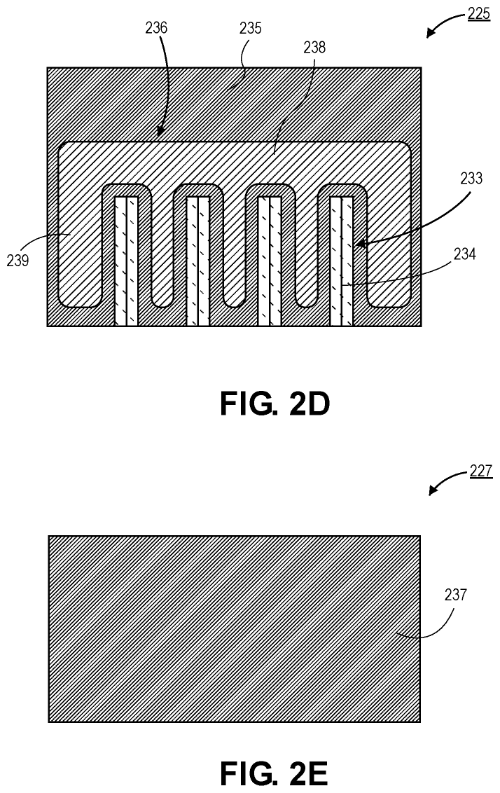

Referring now to FIG. 2A, a perspective view illustration of an optical assembly 220 is shown, in accordance with an embodiment. In an embodiment, the optical assembly 220 may comprise a PIC 225. The PIC 225 may be a die that comprises photonics elements (e.g., a light source and/or a photo detector), The PIC 225 may receive optical signals from fibers 222 and convert those signals into electrical signals. The PIC 225 may also convert electrical signals into optical signals and transmit the optical signals away from the PIC 225 along the fibers 222. In an embodiment, the optical fibers 222 may sit into V-grooves (not visible in FIG. 2A) of the PIC 225 to provide proper alignment.

In an embodiment, a first lid 227 (which may sometimes be referred as a substrate) may be provided over the fibers 222 in order to help retain the fibers 222 in the V-grooves of the PIC 225. In an embodiment, the first lid 227 is mechanically coupled to the PIC 225 by an organic-free adhesive (not shown). For example, the organic-free adhesive may comprise a sintered nanoparticle connector, similar to any of the sintered nanoparticle connectors described in greater detail herein.

In an embodiment, the optical assembly 220 may also comprise an FAU 230. The FAU 230 may comprise a support block 231. The support block 231 may comprise V-grooves (not visible in FIG. 2A) that help align the fibers 222 before the fibers 222 couple to the PIC 225. A second lid 232 may be provided over the support block 231 in order to help retain the fibers 222 in the V-grooves of the support block 231. In some embodiments, the second lid 232 is mechanically coupled to the support block 231 by an organic-free adhesive (not shown). For example, the organic-free adhesive may comprise a sintered nanoparticle connector, similar to any of the sintered nanoparticle connectors described in greater detail herein.

In an embodiment, one or more of the first lid 227, the second lid 232, or the support block 231 may comprise a glass material. In an embodiment, one or more of the first lid 227, the second lid 232, or the support block 231 may comprise a solid block of glass. Any suitable glass formulation that has the necessary mechanical robustness and compatibility with optics manufacturing and assembly processes may be used. For example, the glass material may comprise aluminosilicate glass, borosilicate glass, alumino-borosilicate glass, silica, fused silica, or the like. In some embodiments, the glass material may include one or more additives, such as, but not limited to, Al₂O₃, B₂O₃, MgO, CaO, SrO, BaO, SnO₂, Na₂O, K₂O, SrO, P₂O₃, ZrO₂, Li₂O, Ti, or Zn. More generally, the glass material may comprise silicon and oxygen, as well as any one or more of aluminum, boron, magnesium, calcium, barium, tin, sodium, potassium, strontium, phosphorus, zirconium, lithium, titanium, or zinc. In an embodiment, the glass material may comprise at least 23 percent silicon (by weight) and at least 26 percent oxygen (by weight). In some embodiments, the glass material may further comprise at least 5 percent aluminum (by weight).

Referring now to FIG. 2B, a plan view illustration of a PIC 225 is shown, in accordance with an embodiment. In an embodiment, the PIC 225 may comprise a top surface 226. The top surface 226 of the PIC 225 may comprise any suitable material. In some embodiments, the top surface 226 is a semiconductor, such as silicon. Though, the top surface may also comprise dielectric layers such as an oxide or a nitride. In an embodiment, a plurality of V-grooves 233 may extend from an edge of the PIC 225 into a center of the PIC 225. The bottom seams 234 may be provided where sloped sidewalls of the V-grooves 233 meet at bottoms of the V-grooves 233.

As used herein, a “V-groove” may generally refer to a recess into a substrate that is used to align and/or retain a fiber. For example, a V-groove may have a pair of sloping sidewalls that come to a point at a bottom of the V-groove. In other instances, a V-groove may have sloped sidewalls with bottoms that are connected together by a bottom surface (e.g., a horizontal surface or a curved surface). In such an embodiment, the bottom surface may be below a bottom surface of the fiber so that only the sloping sidewall surfaces contact the fiber. A V-groove may also refer to a groove with vertical sidewalls with a flat bottom surface, a curved bottom surface, or the like. In some instances a V-groove may include a U-shaped groove. More generally, a “groove” may refer to structures that include a V-groove or any other structure for aligning and/or retaining fibers. A groove may have a U-shape in some embodiments.

In an embodiment, one or more pads 235 may be provided on the surface 226 of the PIC 225. The pads 235 may comprise a metallic material (e.g., copper, aluminum, etc.). The pads 235 may be provided to improve adhesion to a subsequently formed nanoparticle connector. In an embodiment, discrete regions of nanoparticle paste 236 may be deposited on each of the pads 235. The nanoparticle paste 236 may be similar to any of the nanoparticle pastes described in greater detail herein. For example, the nanoparticle paste 236 may comprise copper nanoparticles in some embodiments.

Referring now to FIG. 2C a plan view illustration of a lid 227 is shown, in accordance with an embodiment. In an embodiment, the lid 227 may have a bottom surface 229. The bottom surface 229 in FIG. 2C is shown as a substantially flat surface. Though, in other embodiments the lid 227 may also comprise V-grooves (not shown). Pads 237 may be provided at one or more locations across the bottom surface 229. In an embodiment, the positioning of the pads 237 in FIG. 2C may line up with the positioning of the pads 235 on the PIC 225 shown in FIG. 2B when the lid 227 is attached to the PIC 225, as will be described in greater detail below.

Referring now to FIG. 2D, a plan view illustration of a PIC 225 is shown, in accordance with an additional embodiment. In an embodiment, the PIC 225 may be substantially similar to the PIC 225 in FIG. 2B, with the exception of the formation of the pads 235 and the nanoparticle paste 236. Instead of providing pads 235 at discrete locations, a single blanket pad 235 is provided over substantially an entire area of the top surface of the PIC 225. In some embodiments, the pad 235 may not cover surfaces of the V-grooves 233. Though, in other embodiments, the pad 235 may also line the surfaces of the V-grooves 233. While the remainder of the surface of the PIC 225 is covered by the pad 235, the pad 235 may also have an area that is smaller than the area of the top surface of the PIC 225 in some embodiments.

In an embodiment, a nanoparticle paste 236 is dispensed as a continuous structure that wraps around one or more of the V-grooves 233. For example, the nanoparticle paste 236 may have a comb shaped area with a main region 238 that extends across the ends of the V-grooves 233, and a plurality of arm regions 239 that extend along lengths of the V-grooves 233. For example, the nanoparticle paste 236 may be provided along both a first edge of a V-groove 233 and a second edge of a V-groove 233 in some embodiments. While a comb-shaped nanoparticle paste 236 is shown as one example, it is to be appreciated that the nanoparticle paste 236 may be deposited with any pattern in order to provide the necessary mechanical coupling between the PIC 225 and the lid 227.

Referring now to FIG. 2E, a plan view illustration of a lid 227 is shown, in accordance with an additional embodiment. In an embodiment, the lid 227 may comprise a blanket pad 237 that covers an entire surface of the lid 227. The larger blanket pad 237 may be suitable for coupling to the PIC 225 in FIG. 2D.

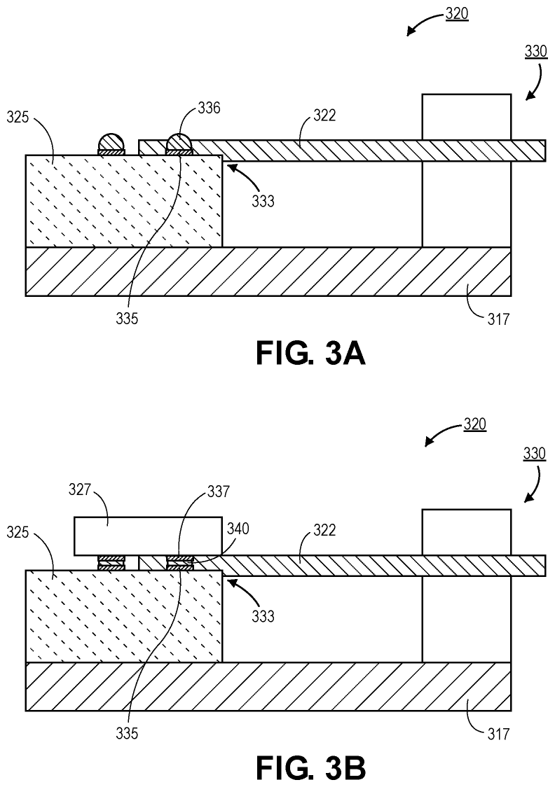

Referring now to FIGS. 3A and 3B, a process for assembling an optical assembly 320 using a nanoparticle paste and sintering process is shown, in accordance with an embodiment. FIGS. 3A and 3B are side views that look at an edge of the optical assembly 320.

Referring now to FIG. 3A, a side view illustration of the optical assembly 320 at a stage of assembly is shown, in accordance with an embodiment. In an embodiment, a PIC 325 and an FAU 330 are set on a substrate 317. The substrate 317 may be an integrated heat spreader (IHS), a package substrate, a board, or any other substrate within an optoelectronic system. In an embodiment, the FAU 330 may comprise a fiber 322 that extends towards the PIC 325 and sets into a V-groove 333 of the PIC 325. The V-groove 333 is not directly visible in FIG. 3A, but it can be inferred since a lower portion of the fiber 322 enters the PIC 325 through the right edge of the PIC 325 in FIG. 3A.

In an embodiment, the PIC 325 may comprise one or more pads 335. The pads 335 may be metallic pads, such as copper or aluminum pads. Nanoparticle paste 336 may be provided over each of the pads 335. The nanoparticle paste 336 may be similar to any of the nanoparticle pastes described in greater detail herein. In an embodiment, the pad 335 and nanoparticle paste 336 layout is similar to the layout shown in FIG. 2B. Though, it is to be appreciated that any pattern or layout of pads 335 or nanoparticle paste 336 may be used in other embodiments.

Referring now to FIG. 3B, a side view illustration of the optical assembly 320 after the lid 327 is pressed against the fiber 322 is shown, in accordance with an embodiment. In an embodiment, the lid 327 presses down against the fiber 322 to retain the fiber 322 within the V-groove 333. In some embodiments, the lid 327 directly contacts the fiber 322. The lid 327 may comprise one or more pads 337 that are aligned with the pads 335 on the PIC 325. The pads 337 press down on the nanoparticle paste 336 so that the nanoparticle paste 336 contacts both the pads 335 and the pads 337.

In an embodiment, after the pads 337 contact the nanoparticle paste 336, a sintering process may be implemented in order to transform the nanoparticle paste 336 into a sintered nanoparticle connector 340. The sintered nanoparticle connector 340 may be similar to any of the sintered nanoparticle structures described in greater detail herein. For example, the sintered nanoparticle connector 340 may comprise a porous metallic structure with fused nanoparticles. The sintered nanoparticle connector 340 may be substantially organic-free. The sintering process may be similar to any of the sintering processes described herein, such as a laser sintering of the nanoparticle paste 336, or sintering through the application of a heated bond head over the nanoparticle paste 336.

In FIGS. 3A and 3B, the nanoparticle paste 336 is applied to the pads 335 on the PIC 325. In other embodiments, the nanoparticle paste 336 may be applied to the pads 337 on the lid 327. Nanoparticle paste 336 may also be applied to both the pads 335 on the PIC 325 and the pads 337 on the lid 327. In the embodiment shown in FIG. 3B, the resulting sintered nanoparticle connectors 340 may have a substantially circular cross-section along a plane parallel to the top surface of the PIC 325.

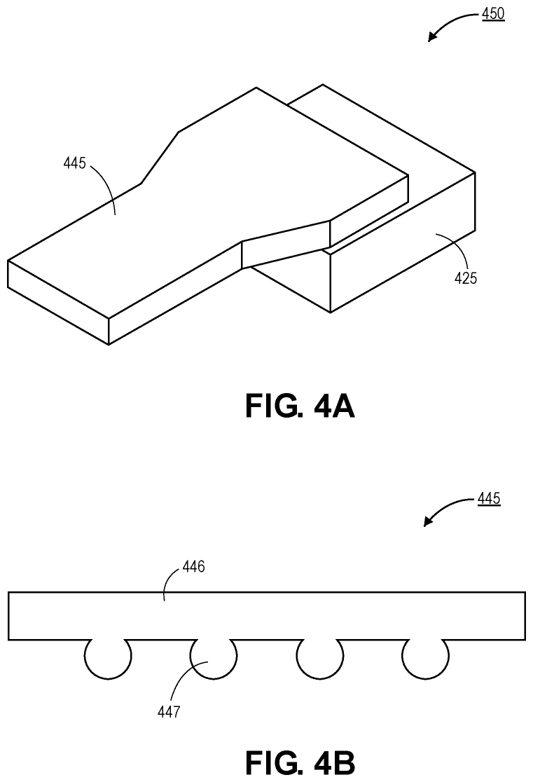

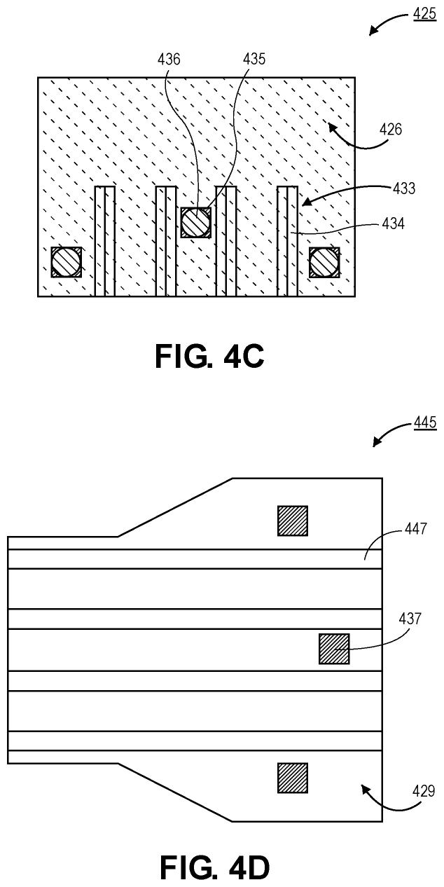

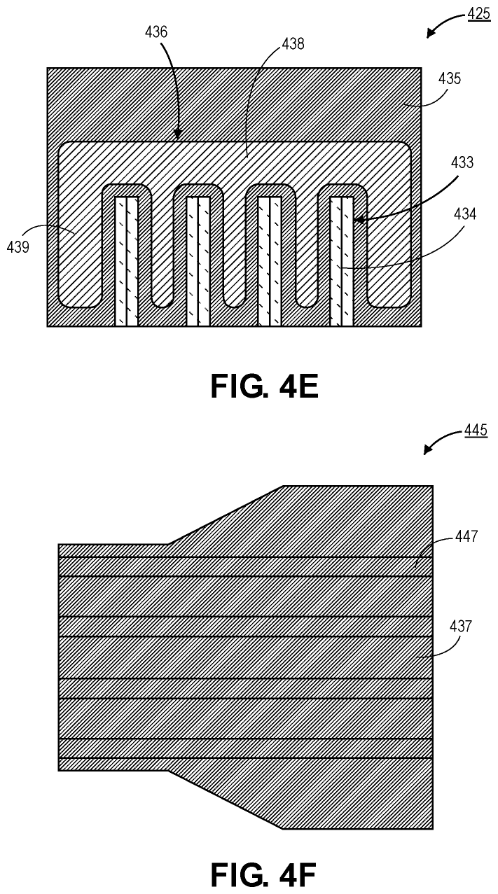

Referring now to FIG. 4A, a perspective view illustration of an optical assembly 450 is shown, in accordance with an embodiment. In an embodiment, the optical assembly 450 may comprise a PIC 425. The PIC 425 may be a die that comprises photonics elements (e.g., a light source and/or a photo detector), The PIC 425 may be similar to any of the PICs described in greater detail herein. For example, the PIC 425 may comprise V-grooves (not visible in FIG. 4).

In an embodiment, the optical assembly 450 may further comprise a waveguide coupler 445. The waveguide coupler 445 may comprise optical waveguides (not visible in FIG. 4A) that sit in the V-grooves of the PIC 425. The waveguide coupler 445 may comprise glass or another material suitable for propagation of optical signals.

Referring now to FIG. 4B, a cross-sectional illustration of the waveguide coupler 445 is shown, in accordance with an embodiment. In an embodiment, the waveguide coupler 445 may comprise a substrate 446 with waveguides 447 extending out from a surface of the substrate 446. The waveguides 447 in FIG. 4B are shown as being substantially circular. Though, in other embodiments the waveguides 447 may have any suitable shape for propagating optical signals.

Referring now to FIG. 4C, a plan view illustration of a PIC 425 is shown, in accordance with an embodiment. In an embodiment, the PIC 425 may comprise a top surface 426. The top surface 426 of the PIC 425 may comprise any suitable material. In some embodiments, the top surface 426 is a semiconductor, such as silicon. Though, the top surface may also comprise dielectric layers such as an oxide or a nitride. In an embodiment, a plurality of V-grooves 433 may extend from an edge of the PIC 425 into a center of the PIC 425. The bottom seams 434 may be provided where sloped sidewalls of the V-grooves 433 meet at bottoms of the V-grooves 433.

In an embodiment, one or more pads 435 may be provided on the surface 426 of the PIC 425. The pads 435 may comprise a metallic material (e.g., copper, aluminum, etc.). The pads 435 may be provided to improve adhesion to a subsequently formed nanoparticle connector. In an embodiment, discrete regions of nanoparticle paste 436 may be deposited on each of the pads 435. The nanoparticle paste 436 may be similar to any of the nanoparticle pastes described in greater detail herein. For example, the nanoparticle paste 436 may comprise copper nanoparticles in some embodiments.

Referring now to FIG. 4D a plan view illustration of a waveguide coupler 445 is shown, in accordance with an embodiment. In an embodiment, the waveguide coupler 445 may have a bottom surface 429. The bottom surface 429 in FIG. 4D may comprise waveguides 447. Pads 437 may be provided at one or more locations across the bottom surface 429. In an embodiment, the positioning of the pads 437 in FIG. 4D may line up with the positioning of the pads 435 on the PIC 425 shown in FIG. 4C when the waveguide coupler 445 is attached to the PIC 425, as will be described in greater detail below.

Referring now to FIG. 4E, a plan view illustration of a PIC 425 is shown, in accordance with an additional embodiment. In an embodiment, the PIC 425 may be substantially similar to the PIC 425 in FIG. 4C, with the exception of the formation of the pads 435 and the nanoparticle paste 436. Instead of providing pads 435 at discrete locations, a single blanket pad 435 is provided over substantially an entire area of the top surface of the PIC 425. In some embodiments, the pad 435 may not cover surfaces of the V-grooves 433. Though, in other embodiments the pad 435 may also line the surfaces of the V-grooves 433. While the remainder of the surface of the PIC 425 is covered by the pad 435, the pad 435 may also have an area that is smaller than the area of the top surface of the PIC 425 in some embodiments.

In an embodiment, a nanoparticle paste 436 is dispensed as a continuous structure that wraps around one or more of the V-grooves 433. For example, the nanoparticle paste 436 may have a comb shaped area with a main region 438 that extends across the ends of the V-grooves 433, and a plurality of arm regions 439 that extend along lengths of the V-grooves 433. For example, the nanoparticle paste 436 may be provided along both a first edge of a V-groove 433 and a second edge of a V-groove 433 in some embodiments. While a comb-shaped nanoparticle paste 436 is shown as one example, it is to be appreciated that the nanoparticle paste 436 may be deposited with any pattern in order to provide the necessary mechanical coupling between the PIC 425 and the waveguide coupler 445.

Referring now to FIG. 4F, a plan view illustration of a waveguide coupler 445 is shown, in accordance with an additional embodiment. In an embodiment, the waveguide coupler 445 may comprise a blanket pad 437 that covers an entire surface of the waveguide coupler 445. The blanket pad 437 may also cover the waveguides 447 in some embodiments. Though, the waveguides 447 may not be covered by the blanket pad 437 in other embodiments. The larger blanket pad 437 may be suitable for coupling to the PIC 425 in FIG. 4E.

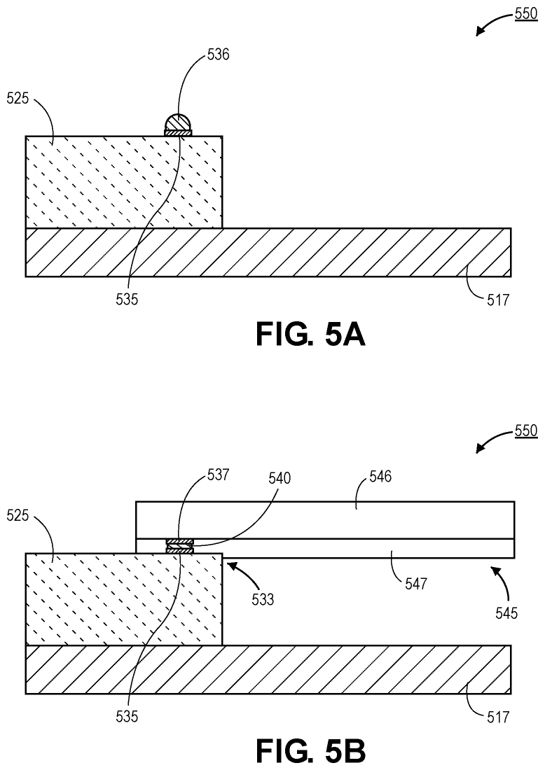

Referring now to FIG. 5A, a side view illustration of the optical assembly 550 at a stage of assembly is shown, in accordance with an embodiment. In an embodiment, a PIC 525 is set on a substrate 517. The substrate 517 may be an IHS, a package substrate, a board, or any other substrate within an optoelectronic system. In an embodiment, the PIC 525 may comprise one or more pads 535. The pads 535 may be metallic pads, such as copper or aluminum pads. Nanoparticle paste 536 may be provided over each of the pads 535. The nanoparticle paste 536 may be similar to any of the nanoparticle pastes described in greater detail herein. In an embodiment, the pad 535 and nanoparticle paste 536 layout is similar to the layout shown in FIG. 5C. Though, it is to be appreciated that any pattern or layout of pads 535 or nanoparticle paste 536 may be used in other embodiments.

Referring now to FIG. 5B, a side view illustration of the optical assembly 550 after a waveguide coupler 545 is coupled to the PIC 525 is shown, in accordance with an embodiment. In an embodiment, the waveguide coupler 545 comprises a substrate 546 with a waveguide 547 that extends out from a bottom surface of the substrate 546. In an embodiment, the waveguide 547 sits into a V-groove 533 of the PIC 525. The V-groove 533 is not directly visible in FIG. 5B, but it can be inferred since a lower portion of the waveguide 547 enters the PIC 525 through the right edge of the PIC 525 in FIG. 5B. The waveguide coupler 535 may comprise one or more pads 537 that are aligned with the pads 535 on the PIC 525. The pads 537 press down on the nanoparticle paste 536 so that the nanoparticle paste 536 contacts both the pads 535 and the pads 537.

In an embodiment, after the pads 537 contact the nanoparticle paste 536, a sintering process may be implemented in order to transform the nanoparticle paste 536 into a sintered nanoparticle connector 540. The sintered nanoparticle connector 540 may be similar to any of the sintered nanoparticle structures described in greater detail herein. For example, the sintered nanoparticle connector 540 may comprise a porous metallic structure with fused nanoparticles. The sintered nanoparticle connector 540 may be substantially organic-free. The sintering process may be similar to any of the sintering processes described herein, such as a laser sintering of the nanoparticle paste 536, or sintering through the application of a heated bond head over the nanoparticle paste 536.

In FIGS. 5A and 5B, the nanoparticle paste 536 is applied to the pads 535 on the PIC 525. In other embodiments, the nanoparticle paste 536 may be applied to the pads 537 on the waveguide coupler 545. Nanoparticle paste 536 may also be applied to both the pads 535 on the PIC 525 and the pads 537 on the waveguide coupler 545. In the embodiment shown in FIG. 5B, the resulting nanoparticle connectors 540 may have a substantially circular cross-section along a plane parallel to the top surface of the PIC 525.

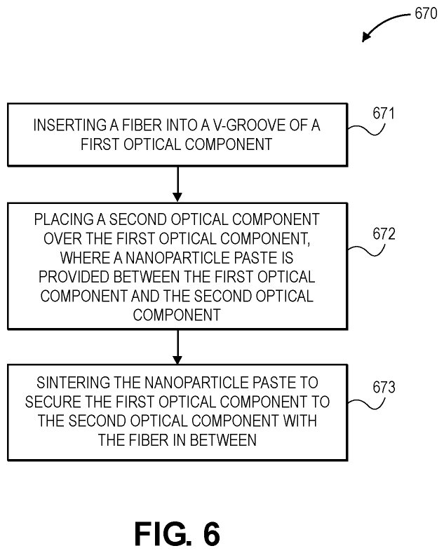

Referring now to FIG. 6, a process flow diagram of a process 670 for mechanically coupling optical components together with an organic-free adhesive based on fused nanoparticles is shown, in accordance with an embodiment. In an embodiment, process 670 may begin with operation 671, which comprises inserting a fiber into a V-groove of a first optical component. In an embodiment, the first optical component may be a PIC or the like. In an embodiment, the process 670 may continue with operation 672, which comprises placing a second optical component over the first optical component. In an embodiment, a nanoparticle paste is provided between the first optical component and the second optical component. In an embodiment, a pad may separate the nanoparticle paste from one or both of the first optical component and the second optical component. The second optical component may be lid in some embodiments. In an embodiment, the nanoparticle paste may be similar to any of the nanoparticle pastes described in greater detail herein.

In an embodiment, the process 670 may continue with operation 673, which comprises sintering the nanoparticle paste to secure the first optical component to the second optical component with the fiber in-between. In an embodiment, the sintering process may include the localized application of heat to the nanoparticle paste in order to fuse together nanoparticles. The localized heat may be applied with a laser or a heated bond head. In some embodiments, any organic flux material may be removed during and/or after the sintering process.

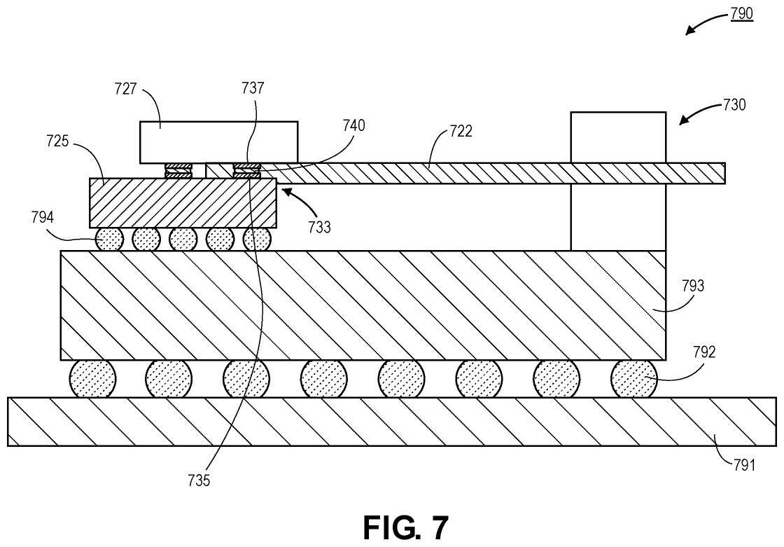

Referring now to FIG. 7, a cross-sectional illustration of an optoelectronic system 790 is shown, in accordance with an embodiment. The electronic system 790 may comprise a board 791, such as a printed circuit board (PCB), a motherboard, or the like. The board 791 may be coupled to a package substrate 793 through second level interconnects (SLIs) 792. The SLIs 792 may comprise solder joints, pins, sockets, or the like.

In an embodiment, the optoelectronic system 790 may comprise an FAU 730 that is optically coupled to a PIC 725 by an optical fiber 722. In an embodiment, the fiber 722 may sit in a V-groove 733 of the PIC 725. The fiber 722 may be retained in the V-groove 733 by a lid 727. In an embodiment, the lid 727 is mechanically coupled to the PIC 725 by a sintered nanoparticle connector 740. The sintered nanoparticle connector 740 may be similar to any of the sintered nanoparticle materials described herein. For example, the sintered nanoparticle connector 740 may comprise fused copper nanoparticles, and the sintered nanoparticle connector 740 may be a substantially organic-free material. The sintered nanoparticle connector 740 may be provided between a pads 735 on the PIC 725 and pads 737 on the lid 727.

In an embodiment, the PIC 725 may be coupled to the package substrate 793 by any suitable first level interconnect (FLI) 794 architecture. For example, FLIs 794 may comprise solder bumps, copper bumps, hybrid bonding, and/or the like. In an embodiment, the PIC 795 may convert optical signals to electrical signals and vice-versa. The PIC 725 may be communicatively coupled to a die (not shown) that is configured to process data delivered along the optical fiber 722. The die may be any type of die, such as a central processing unit (CPU), a graphics processing unit (GPU), an XPU, a communications die, a memory die, or the like.

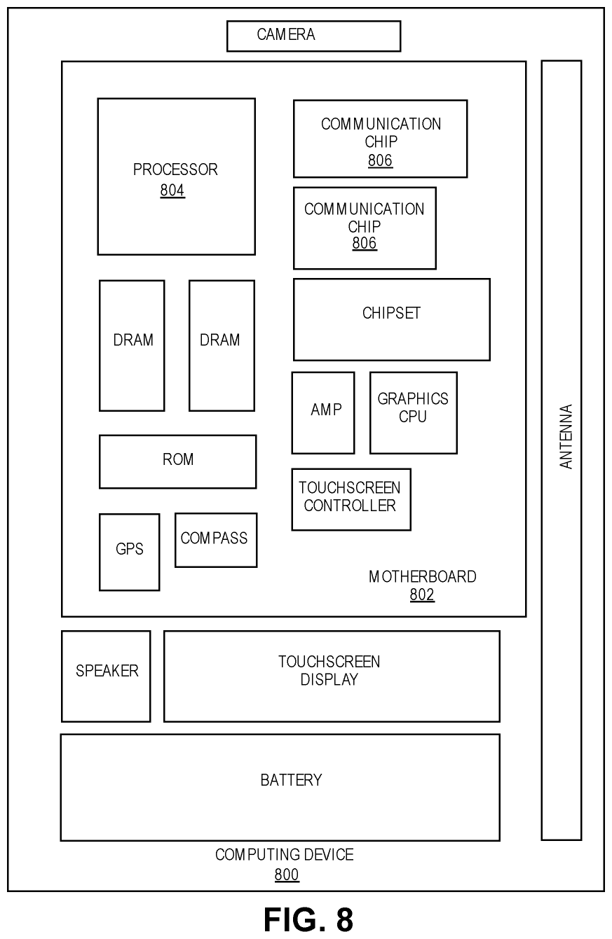

FIG. 8 illustrates a computing device 800 in accordance with one implementation of the disclosure. The computing device 800 houses a board 802. The board 802 may include a number of components, including but not limited to a processor 804 and at least one communication chip 806. The processor 804 is physically and electrically coupled to the board 802. In some implementations the at least one communication chip 806 is also physically and electrically coupled to the board 802. In further implementations, the communication chip 806 is part of the processor 804.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 806 enables wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 806 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

The processor 804 of the computing device 800 includes an integrated circuit die packaged within the processor 804. In some implementations of the disclosure, the integrated circuit die of the processor may be part of an optical package that includes a PIC that is mechanically coupled to another substrate through the use of a substantially organic-free sintered nanoparticle connector, in accordance with embodiments described herein. The term “processor” may refer to any device or portion of a device that processes electronic data from registers and/or memory to transform that electronic data into other electronic data that may be stored in registers and/or memory.

The communication chip 806 also includes an integrated circuit die packaged within the communication chip 806. In accordance with another implementation of the disclosure, the integrated circuit die of the communication chip may be part of an optical package that includes a PIC that is mechanically coupled to another substrate through the use of a substantially organic-free sintered nanoparticle connector, in accordance with embodiments described herein.

In an embodiment, the computing device 800 may be part of any apparatus. For example, the computing device may be part of a personal computer, a server, a mobile device, a tablet, an automobile, or the like. That is, the computing device 800 is not limited to being used for any particular type of system, and the computing device 800 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus, comprising: a first substrate; a groove in a surface of the first substrate; a fiber in the groove; a second substrate over the first substrate and the fiber; and a porous metallic material between the first substrate and the second substrate.

Example 2: the apparatus of Example 1, wherein the porous metallic material is a sintered nanoparticle material.

Example 3: the apparatus of Example 2, wherein the sintered nanoparticle material comprises one or more of copper nanoparticles, silver nanoparticles, or gold nanoparticles.

Example 4: the apparatus of Examples 1-3, wherein a porosity of the porous metallic material is between 0% porous and 50% porous.

Example 5: the apparatus of Examples 1-4, further comprising: a first pad on the first substrate; and a second pad on the second substrate, wherein the porous metallic material contacts the first pad and the second pad.

Example 6: the apparatus of Examples 1-5, wherein the second substrate contacts the fiber.

Example 7: the apparatus of Examples 1-6, wherein the first substrate is a photonic integrated circuit (PIC).

Example 8: the apparatus of Example 7, wherein the second substrate is a glass block.

Example 9: the apparatus of Examples 1-8, wherein the porous metallic material has a circular cross section in a plane parallel to the surface of the first substrate.

Example 10: the apparatus of Examples 1-9, wherein the porous metallic material is adjacent to a first edge of the groove and a second edge of the groove.

Example 11: an apparatus, comprising: a photonics die; a V-groove in a first surface of the photonics die; a first pad on the first surface of the photonics die; a substrate over the photonics die; a second pad on a second surface of the substrate that faces the first surface of the photonics die; and a connector between the first pad and the second pad, wherein the connector comprises fused nanoparticles.

Example 12: the apparatus of Example 11, wherein the fused nanoparticles comprise one or more of copper, silver, or gold.

Example 13: the apparatus of Example 11 or Example 12, wherein the fused nanoparticles have an average diameter of up to 250 nm.

Example 14: the apparatus of Examples 11-13, wherein a melting temperature of the connector is 400° C. or more.

Example 15: the apparatus of Examples 11-14, wherein the first pad and the second pad comprise copper and/or aluminum.

Example 16: the apparatus of Examples 11-15, wherein the substrate comprises a waveguide, and wherein the waveguide sits in the V-groove.

Example 17: the apparatus of Examples 11-16, further comprising: a fiber in the V-groove, wherein the fiber is contacted by the substrate.

Example 18: an apparatus, comprising: a photonics integrated circuit (PIC) with a V-groove; a fiber array unit (FAU) adjacent to the PIC, wherein the FAU comprises a fiber that extends over the PIC and sits in the V-groove; a substrate over the PIC, wherein the substrate contacts the fiber; and an organic-free adhesive configured to mechanically couple the substrate to the PIC.

Example 19: the apparatus of Example 18, wherein the organic-free adhesive comprises a porous metallic material.

Example 20: the apparatus of Example 19, wherein the porous metallic material comprise sintered nanoparticles.

What is claimed is:

1. An apparatus, comprising:
a first substrate;
a groove in a surface of the first substrate;
a fiber in the groove;
a second substrate over the first substrate and the fiber; and
a porous metallic material between the first substrate and the second substrate.

2. The apparatus of claim 1, wherein the porous metallic material is a sintered nanoparticle material.

3. The apparatus of claim 2, wherein the sintered nanoparticle material comprises one or more of copper nanoparticles, silver nanoparticles, or gold nanoparticles.

4. The apparatus of claim 1, wherein a porosity of the porous metallic material is between 0% porous and 50% porous.

5. The apparatus of claim 1, further comprising:
a first pad on the first substrate; and
a second pad on the second substrate, wherein the porous metallic material contacts the first pad and the second pad.

6. The apparatus of claim 1, wherein the second substrate contacts the fiber.

7. The apparatus of claim 1, wherein the first substrate is a photonic integrated circuit (PIC).

8. The apparatus of claim 7, wherein the second substrate is a glass block.

9. The apparatus of claim 1, wherein the porous metallic material has a circular cross section in a plane parallel to the surface of the first substrate.

10. The apparatus of claim 1, wherein the porous metallic material is adjacent to a first edge of the groove and a second edge of the groove.

11. An apparatus, comprising:
a photonics die;
a V-groove in a first surface of the photonics die;
a first pad on the first surface of the photonics die;
a substrate over the photonics die;
a second pad on a second surface of the substrate that faces the first surface of the photonics die; and
a connector between the first pad and the second pad, wherein the connector comprises fused nanoparticles.

12. The apparatus of claim 11, wherein the fused nanoparticles comprise one or more of copper, silver, or gold.

13. The apparatus of claim 11, wherein the fused nanoparticles have an average diameter of up to 250 nm.

14. The apparatus of claim 11, wherein a melting temperature of the connector is 400° C. or more.

15. The apparatus of claim 11, wherein the first pad and the second pad comprise copper and/or aluminum.

16. The apparatus of claim 11, wherein the substrate comprises a waveguide, and wherein the waveguide sits in the V-groove.

17. The apparatus of claim 11, further comprising:
a fiber in the V-groove, wherein the fiber is contacted by the substrate.

18. An apparatus, comprising:
a photonics integrated circuit (PIC) with a V-groove;
a fiber array unit (FAU) adjacent to the PIC, wherein the FAU comprises a fiber that extends over the PIC and sits in the V-groove;
a substrate over the PIC, wherein the substrate contacts the fiber; and
an organic-free adhesive configured to mechanically couple the substrate to the PIC.

19. The apparatus of claim 18, wherein the organic-free adhesive comprises a porous metallic material.

20. The apparatus of claim 19, wherein the porous metallic material comprise sintered nanoparticles.
